(19) United States
(12) Patent Application Publication
(10) Pub. No.: US 2025/0210655 A1
(43) Pub. Date: Jun. 26, 2025

(54) ELECTRODE ACTIVE MATERIALS AND MIXED ELECTRODE ACTIVE MATERIALS FOR LITHIUM BATTERIES

(71) Applicant: TexPower EV Technologies Inc., Houston, TX (US)

(72) Inventors: Wangda LI, Houston, TX (US); Julia LAMB, Haverhill, MA (US); Aaron LIU, Houston, TX (US); Ryan PEKAREK, Houston, TX (US)

(73) Assignee: TexPower EV Technologies Inc., Houston, TX (US)

(21) Appl. No.: 18/990,896

(22) Filed: Dec. 20, 2024

Related U.S. Application Data
(60) Provisional application No. 63/613,859, filed on Dec. 22, 2023.

(51) Int. Cl. H01M 4/58; H01M 4/02; H01M 4/131; H01M 4/36; H01M 4/525; H01M 4/62; H01M 10/0525

(52) U.S. Cl. CPC H01M 4/5825; H01M 4/131; H01M 4/364; H01M 4/525; H01M 4/625; H01M 10/0525; H01M 2004/028

(57) ABSTRACT

Described herein are electrode active materials useful as the positive electrode in lithium or lithium-ion batteries. The disclosed electrode active materials comprise lithium phosphates uniquely suited for mixing with lithium layered oxides, as well as the resulting mixture. For example, compositions of matter are described herein. The disclosed materials exhibit high energy density with reduced cobalt and nickel content.

### CROSS-REFERENCE TO RELATED APPLICATIONS

This application claims priority to and the benefit of U.S. Provisional Patent Application No. 63/613,859, entitled “Electrode Active Materials And Mixed Electrode Active Materials For Lithium Batteries,” filed Dec. 22, 2023, the entire disclosure-of which is incorporated by reference herein for all purposes.

### FIELD

This invention is in the field of lithium batteries. This invention relates generally to manganese-containing cathodes with the olivine structure, and mixed cathodes containing the olivine type and layered-oxide type cathodes.

### BACKGROUND

Olivine-structured materials for lithium-ion batteries, such as lithium iron phosphate (LiFePO₄), have been studied since the 1990's as suitable cathode active materials thanks to the work of Dr. Goodenough and colleagues. Lithium iron phosphate is a popular cathode active material on the market today due to its affordability, safety, and longevity. Lithium manganese phosphate is another studied cathode active material, however, it never garnered interest in the battery market. Compared to lithium iron phosphate, lithium manganese phosphate has lower ionic and electronic conductivity, in addition to worse stability because of Jahn-Teller distortions and manganese dissolution during battery operation.

Layered-oxide cathode materials have higher energy density but worse stability than the olivine-structured phosphate materials, making them suitable for applications where battery size and mass is important. In addition to worse stability, layered-oxide cathode materials are heavily reliant on expensive and problematic resources. Most commercial layered-oxide cathode materials contain cobalt, such as LiCoO₂ (LCO), Li[NiₐMn_{b}Co_{c}]O₂ (a+b+c=1; NMC-abc), and Li[Ni_{1-x-y}CoₓAl_{y}]O₂ (NCA). Cobalt is a scarce metal and can only be found in a few places on Earth, such as the Democratic Republic of Congo. Political, environmental, and ethical concerns have caused a growing consensus to reduce cobalt usage in lithium-ion batteries. Reducing cobalt content typically involves increasing nickel content to maintain a high energy density in the layered-oxide cathode. However, the availability of battery-grade nickel sulfate has collapsed in recent years due to lack of naturally occurring deposits. The resulting market volatility led to an increase in synthetically produced battery-grade nickel sulfate. The synthetically produced material is more expensive and has twenty times higher CO₂ emissions than the naturally occurring ore, causing a new market push towards reducing nickel content.

### SUMMARY

By combining lithium iron phosphate and lithium manganese phosphate materials into a lithium iron manganese phosphate (LiFe₁₋ₓMnₓPO₄), a cathode active material may achieve higher energy density than lithium iron phosphate by sacrificing conductivity and stability. Despite the higher energy density, lithium iron manganese phosphate materials may still less energy dense than lithium layered-oxide materials, in which case they may be undesirable for high-energy applications.

Blending layered-oxide cathode materials with olivine-structured cathode materials may allow for a reduction of nickel and cobalt content, but challenges remain. One such challenge is the large potential difference between the two materials. During cycling with a large potential difference, only one material may be active at any given time, causing a higher effective charge rate, which decreases overall energy and longevity of a mixture. Another challenge is the physical compatibility of the two materials. In addition to different stability during cycling, layered-oxide cathode materials are sensitive to air and moisture, while olivine-structured phosphate materials typically contain high moisture content.

Described herein are olivine-structured lithium cathode materials useful for mixing with lithium layered-oxide cathode materials to produce a low or no-cobalt, lower-nickel cathode mixture for lithium-ion batteries. For example, compositions of matter are described herein, such as electrode active materials. The electrode active materials can be incorporated into an electrode, such as a cathode. The electrode active material can be in the form of a powder, which can be assembled as a cathode active material over a current collector, such as using slurry-based deposition or assembly techniques.

The disclosed electrode active materials can also be incorporated into or used in an electrochemical device. For example, the electrode active materials can be incorporated into a cathode, and/or in an electrochemical cell with an anode and an electrolyte positioned between the cathode and the anode. Other components may also be used in an electrochemical device, such as a separator, current collectors, packaging, or the like. In some cases, one or multiple electrochemical cells may be incorporated into or used in a battery. The cathode or the anode or both may independently comprise one or more of an active material, a current collector, a binder, a conductive additive, or other components.

Example materials useful for the anode of an electrochemical cell incorporating the electrode active materials described herein as an anode active material include, but are not limited to, graphite, carbon, silicon, lithium titanate (Li₄Ti₅O₁₂), tin, antimony, zinc, phosphorous, lithium, or a combination thereof. In some examples, useful electrolytes include liquid electrolytes and solid electrolytes. Non-aqueous electrolytes, such as those with carbonate-based solvents, may be used.

The olivine-structured lithium cathode material may comprise LiₐFe_{1-b-c}Mn_{b}M_{c}PO₄/C, where a may be from 0.9 to 1.1, b may be from 0 to 1, c may be from 0 to 0.1, M may be Ni, Al, Mg, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm or any combination of these, and C may be a carbon content of between 0% to 3% by weight.

The olivine-structured lithium cathode material is useful for mixing with a lithium layered-oxide cathode material, such as one comprising Li_{d}Ni_{1-e-f}CoₑM_{f}O_{g} where d may be from 0.9 to 1.1, e may be from 0 to 0.05, f may be from 0 to 0.6, g may be from 1.9 to 2.1, and M may be Mn, Al, Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm, or any combination of these.

Lithium layered-oxide cathodes can suffer from a reliance on expensive metals and poor stability that may be mitigated by mixing with olivine-structured cathode materials. However, mixing different cathode materials can cause a two-step profile during cycling where one of the materials is active, followed by the other material. This two-step profile can cause the current rate exhibited on each material to be higher than the imposed current rate on the cell, leading to poor energy and stability. The two-step profile may be avoided by mixing cathode materials with similar voltage profiles, such that lithiation and de-lithiation occurs around the same time and under close or the same voltage conditions. Mixing lithium layered-oxide cathodes with olivine-structured cathodes may, therefore, be more effective when the olivine-structured cathode contains manganese because of the increased average voltage, bringing it closer to the average voltage of lithium layered-oxide cathodes. In addition to voltage considerations are materials compatibility considerations. Lithium layered-oxide cathodes often suffer from a sensitivity to water which causes lithium to be extracted from the structure and form a resistive Li₂CO₃ layer on the surface, decreasing capacity and increasing resistance. Advantageously, the olivine-structured cathode material described herein may exhibit low moisture content to prevent lithium layered-oxide degradation. Advantageously, the electrode active materials and mixtures described herein may also be characterized by good physical and electrochemical characteristics such as high density, low surface area, low resistivity, low N-Methylpyrrolidone (NMP) absorption for improved slurry casting, high coulombic efficiency, capacity, low-temperature performance, rate capability, and energy density.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 is a schematic illustration of an example electrochemical cell according to at least some aspects of the present disclosure.

### DETAILED DESCRIPTION

The present disclosure details a class of olivine-structured lithium cathode materials suitable for mixing with no or low-cobalt lithium layered-oxide cathode materials. The mixture of the two materials is a unique blend for use as the cathode active material of a lithium-ion battery that minimizes the use of nickel and cobalt without sacrificing performance.

With the rapid expansion of global electric mobility, there is a growing consensus to reduce cathode material dependence on both cobalt and nickel. Both metals are highly vulnerable to supply constraints and price volatility, while cobalt additionally raises toxicity and humanitarian concerns due to the mining practices in central Africa. One method for eliminating both problematic metals is by replacing lithium layered-oxide cathode materials with the olivine-structured lithium iron phosphate. However, lithium iron phosphate cannot meet the stringent energy density requirements of many electric vehicles, particularly those for the US market. Substituting some manganese for iron decreases the specific capacity of the olivine material but increases the average voltage, leading to a small overall boost to energy density. Although the energy density of manganese substituted lithium iron phosphate is still insufficient for most electric vehicle and high-energy requirements, the higher average voltage provides an opportunity for mixing with a lithium layered-oxide cathode.

The described materials are tuned for mutual compatibility and can be modified in chemical composition to provide a wide range of specific performance metrics, such as high specific energy, high voltage, high rate capability, and/or long operational lifetime over a wide temperature range (from subzero to elevated temperatures), as well as desirable safety features under abuse (e.g., short circuit, overcharge, rupture). These materials are readily compatible with existing components in commercial lithium-ion batteries, such as graphite/silicon anodes, polymeric separators, and nonaqueous electrolytes.

Both the olivine-structured lithium cathode materials and the lithium layered-oxide cathode materials can be synthesized via various manufacturing processes, such as solid-state synthesis, co-precipitation, lithiation calcination, and/or post-calcination treatments. A series of metals or non-metals can be incorporated into the cathodes to achieve good voltage overlap such that both materials are consistently active during cycling. The olivine-structured lithium cathode materials can also be thoroughly dried for compatibility with moisture-sensitive lithium layered-oxide cathodes. The described cathodes demonstrate promise for more affordable, fairly sourced, and sustainable lithium-based batteries, including both lithium-ion and lithium-metal chemistries in either liquid, semi-solid, or all-solid-state electrolyte systems.

### Olivine Cathode Materials

The olivine-structured lithium cathode materials described herein, also referred to as olivine cathodes, olivine phosphates, or phosphate cathodes, are characterized by the chemical formula LiₐFe_{1-b-c}Mn_{b}M_{c}PO₄/C. M represents any combination of metal or non-metal dopants, such as Ni, Al, Mg, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm. The oxygen may optionally be substituted with 0.1 mole % or less of any combination of B, N, O, F, Al, Si, P, S, Cl, Se, or Br. C represents a carbon coating between about 0% to 3% by weight and may be in any suitable form, for example as an amorphous species, nanotubes, graphene, flakes, nanospheres, graphene oxide, or pyrolyzed carbon. The carbon may optionally be doped with any combination of B, N, O, F, Al, Si, P, S, Cl, Se, or Br.

The subscript a in the chemical formula LiₐFe_{1-b-c}Mn_{b}M_{c}PO₄/C represents the relative amount of Li (lithium) in the olivine cathode. Synthesis conditions may vary, causing slightly lithium-deficient or lithium-excess compositions while still maintaining a highly crystalline material. For example, a may be from about 0.9 to about 1.1, from 0.9 to 1.09, from 0.9 to 1.08, from 0.9 to 1.07, from 0.9 to 1.06, from 0.9 to 1.05, from 0.9 to 1.04, from 0.9 to 1.03, from 0.9 to 1.02, from 0.9 to 1.01, from 0.9 to 1.0, from 0.91 to 1.1, from 0.92 to 1.1, from 0.93 to 1.1, from 0.94 to 1.1, from 0.95 to 1.1, from 0.96 to 1.1, from 0.97 to 1.1, from 0.98 to 1.1, from 0.99 to 1.1, or from 0.95 to 1.05.

The subscript b in the chemical formula LiₐFe_{1-b-c}Mn_{b}M_{c}PO₄/C represents the relative amount of Mn (manganese) in the olivine cathode. Example values of b include from about 0 to 1, from 0.05 to 1, from 0.1 to 1, from 0.15 to 1, from 0.2 to 1, from 0.25 to 1, from 0.3 to 1, from 0.35 to 1, from 0.4 to 1, from 0.45 to 1, from 0.5 to 1, from 0.55 to 1, from 0.6 to 1, from 0 to 0.95, from 0.05 to 0.95, from 0.1 to 0.95, from 0.15 to 0.95, from 0.2 to 0.95, from 0.25 to 0.95, from 0.3 to 0.95, from 0.35 to 0.95, from 0.4 to 0.95, from 0.45 to 0.95, from 0.5 to 0.95, from 0.55 to 0.95, from 0.6 to 0.95, from 0 to 0.9, from 0.05 to 0.9, from 0.1 to 0.9, from 0.15 to 0.9, from 0.2 to 0.9, from 0.25 to 0.9, from 0.3 to 0.9, from 0.35 to 0.9, from 0.4 to 0.9, from 0.45 to 0.9, from 0.5 to 0.9, from 0.55 to 0.9, or from 0.6 to 0.9.

The subscript c in the chemical formula LiₐFe_{1-b-c}Mn_{b}M_{c}PO₄/C represents the relative amount of metal(s) and/or non-metal(s), M, in the olivine cathode. Example values of c from about 0 to 0.1, from 0 to 0.095, from 0 to 0.09, from 0 to 0.085, from 0 to 0.08, from 0 to 0.075, from 0 to 0.07, from 0 to 0.065, from 0 to 0.06, from 0 to 0.055, from 0 to 0.05, from 0 to 0.045, from 0 to 0.04, from 0 to 0.035, from 0 to 0.03, from 0 to 0.025, from 0 to 0.02, from 0 to 0.015, from 0 to 0.01, from 0.01 to 0.1, from 0.01 to 0.095, from 0.01 to 0.09, from 0.01 to 0.085, from 0.01 to 0.08, from 0.01 to 0.075, from 0.01 to 0.07, from 0.01 to 0.065, from 0.01 to 0.06, from 0.01 to 0.055, or from 0.01 to 0.05.

The olivine cathode materials may be characterized by a low moisture content for the purpose of minimizing lithium layered-oxide cathode degradation when mixed. When lithium layered oxides are exposed to water, lithium can be extracted from the bulk and form LiOH on the surface which can be converted to Li₂CO₃ upon exposure to CO₂ in the air. Both LiOH and Li₂CO₃ are referred to as residual lithium or surface lithium species. Additional benefits of the low moisture content may include less slurry gelation during cathode processing, less clumping of the olivine cathode particles resulting in easier and less bumpy electrode processing, and fewer harmful interactions between water and the electrolyte during battery operation. Example values of the olivine cathode moisture content are about 800 ppm or less, 700 ppm or less, 600 ppm or less, 500 ppm or less, 400 ppm or less, or 300 ppm or less. Moisture may be measured using a standard Karl-Fischer titration, thermogravimetric analysis (TGA), or other sensitive technique.

The olivine cathode materials may optionally be characterized by a high density relative to other olivine cathode materials, such as tap density or pressed density, which allows for greater mass per unit volume and correspondingly, greater energy per unit volume. Tap density may be measured by repeatedly tapping the olivine cathode powder to minimize void space between particles. Example values are from about 0.5 g·cm⁻³ to about 1.5 g·cm⁻³, such as about 0.5 g·cm⁻³, 0.6 g·cm⁻³, 0.7 g·cm⁻³, 0.8 g·cm⁻³, 0.9 g·cm⁻³, 1.0 g·cm⁻³, 1.1 g·cm⁻³, 1.2 g·cm⁻³, 1.3 g·cm⁻³, 1.4 g·cm⁻³, or 1.5 g·cm⁻³. Pressed density may be measured by exerting a force over a given volume of powder such that the pressure is about 275 MPa or less. It will be appreciated that higher exerted pressures can lead to higher density values. Pressed density is a standard measurement for understanding how the material will behave during the calendaring step of the electrode preparation process, and what cathode-level density values to expect. Example values are from about 2 g·cm⁻³to about 3 g·cm⁻³, such as about 2.0 g·cm⁻³, 2.1 g·cm⁻³, 2.2 g·cm⁻³, 2.3 g·cm⁻³, 2.4 g·cm⁻³, 2.5 g·cm⁻³, 2.6 g·cm⁻³, 2.7 g·cm⁻³, 2.8 g·cm⁻³, 2.9 g·cm⁻³, or 3.0 g·cm⁻³.

The electric and ionic conductivity of olivine cathode materials can be low, such that small particle size and a carbon coating are useful to improve conductivity. For the purpose of mixing with lithium layered oxides or bonding to the lithium layered-oxide particle surface, the mixture should not be limited by the olivine cathode conductivity. Resistivity measurements may be taken on the dry powder to quantify material-level conductivity. Example values are from about 10 Ω·cm to about 100 Ω·cm, from 10 Ω·cm to 90 Ω·cm, from 10 Ω·cm to 80 Ω·cm, from 10 Ω·cm to 70 Ω·cm, from 10 Ω·cm 60 Ω·cm, from 10 Ω·cm to 50 Ω·cm, from 10 Ω·cm to 40 Ω·cm, from 10 Ω·cm to 30 Ω·cm, or from 10 Ω·cm to 20 Ω·cm, such as about 10 Ω·cm, 20, Ω·cm, 30, Ω·cm, 40 Ω·cm, 50 Ω·cm, 60 Ω·cm, 70 Ω·cm, 80 Ω·cm, 90 Ω·cm, or 100 Ω·cm.

A high surface area may be beneficial for improving electric and ionic conductivity; however, it can also increase solvent absorption. Absorption in the present disclosure may be defined as either absorption, adsorption, or both. Reducing N-Methylpyrrolidone (NMP) usage during slurry processing reduces costs, improves processing safety, and increases electrode thickness, thereby improving cell-level energy density. The present olivine cathode materials may be characterized by a low surface area of about 1 m²·g⁻¹ to about 100 m²·g⁻¹, or about 1 m²·g⁻¹ to about 50 m²·g⁻¹, or about 1 m²·g⁻¹ to about 25 m²·g⁻¹, such as a surface area of about 1 m²·g⁻¹ to about 20 m²·g⁻¹ or a surface area of about 1 m²·g⁻¹ to about 10 m²·g⁻¹. Example surface area values include about 1 m²·g⁻¹, 2 m²·g⁻¹, 4 m²·g⁻¹, 6 m²·g⁻¹, 8 m²·g⁻¹, 10 m²·g⁻¹, 12 m²·g⁻¹, 14 m²·g⁻¹, 16 m²·g⁻¹, 18 m²·g⁻¹, 20 m²·g⁻¹, 25 m²·g⁻¹, 30 m²·g⁻¹, 40 m²·g⁻¹, 50 m²·g⁻¹, 60 m²·g⁻¹, 70 m²·g⁻¹, 80 m²·g⁻¹, 90 m²·g⁻¹, or 100 m²·g⁻¹. Additionally, the solvent absorption content may be approximated with a standard oil absorption test, such as the spatula rub-out ASTM D281 method, using dibutyl phthalate (DBP) oil. Example values of DBP absorption may range from about 100 mL per 100 g of olivine cathode to about 500 mL per 100 g of olivine cathode, or from 100 mL to 400 mL, or from 100 mL to 300 mL, or from 100 mL to 200 mL, such as about 100 mL, 150 mL, 200 mL, 250 mL, 300 mL, 350 mL, 400 mL, 450 mL, or 500 mL. Alternatively, the content of NMP necessary for electrode preparation may be closely approximated by substituting the oil for NMP in a standard oil absorption test. Example values of NMP absorption may be from about 0.5 mL per 100 g of olivine cathode to about 5 mL per 100 g of olivine cathode, or from 0.5 mL to 4.5 mL, or from 0.5 mL to 4 mL, or from 0.5 mL to 3.5 mL, or from 0.5 mL to 3 mL, such as about 0.5 mL per 100 g, 1 mL per 100 g, 1.5 mL per 100 g, 2 mL per 100 g, 2.5 mL per 100 g, 3 mL per 100 g, 3.5 mL per 100 g, 4 mL per 100 g, 4.5 mL per 100 g, or 5 mL per 100 g. Furthermore, the oil absorption test may be used to approximate necessary electrolyte content in a cell made with the olivine cathode materials by substituting oil for a carbonate solvent. Example values of carbonate solvent absorption may include about 10 mL per 100 g of olivine cathode to about 500 mL per 100 g of olivine cathode, or from 10 mL to 400 mL, or from 10 mL to 300 mL, or from 10 mL to 200 mL, or from 10 mL to 100 mL, such as about 10 mL, 50 mL, 100 mL, 150 mL, 200 mL, 250 mL, 300 mL, 350 mL, 400 mL, 450 mL, or 500 mL per 100 g.

The present olivine cathode materials may be characterized by a small particle size for the purpose of increasing conductivity in addition to increasing density when mixed with larger lithium layered-oxide particles. For example, the median particle size (D50) may be from about 0.2 μm to about 5 μm, from 0.2 μm to 4.5 μm, from 0.2 μm to 4 μm, from 0.2 to 3.5 μm, from 0.2 μm to 3 μm, from 0.2 μm to 2.5 μm, from 0.2 μm to 2 μm, or from 0.2 μm to 1.5 μm, such as about 0.2 μm, 0.3 μm, 0.4 μm, 0.5 μm, 0.6 μm, 0.7 μm, 0.8 μm, 0.9 μm, 1.0 μm, 1.1 μm, 1.2 μm, 1.3 μm, 1.4 μm, 1.5 μm, 1.6 μm, 1.7 μm, 1.8 μm, 1.9 μm, 2.0 μm, 2.1 μm, 2.2 μm, 2.3 μm, 2.4 μm, 2.5 μm, 2.6 μm, 2.7 μm, 2.8 μm, 2.9 μm, 3.0 μm, 3.1 μm, 3.2 μm, 3.3 μm, 3.4 μm, 3.5 μm, 3.6 μm, 3.7 μm, 3.8 μm, 3.9 μm, 4.0 μm, 4.1 μm, 4.2 μm, 4.3 μm, 4.4 μm, 4.5 μm, 4.6 μm, 4.7 μm, 4.8 μm, 4.9 μm, or 5.0 μm. D50 refers to the size of particles in the 50^{th} percentile of the particle population, e.g., median particle size. D90 and D99 refer to the particle size distribution, e.g., the size of particles in the 90^{th} and 99^{th} percentile of the particle population, respectively. A narrow particle size distribution may be preferrable for the purpose of improving slurry and electrode uniformity. The olivine cathode materials may be characterized by a D90 of between about 0.5 μm to 10 μm, or between about 1 μm to about 10 μm, or between about 0.5 μm to about 5 μm, or between about 1 μm to about 5 μm, such as about 0.5 μm, 1 μm, 2 μm, 3 μm, 4 μm, 5 μm, 6 μm, 7 μm, 8 μm, 9 μm, or 10 μm. The D99 may be between about 1 μm to about 20 μm, or between about 1 μm to about 10 μm, such as about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm. The particle size distribution may, for example, be characterized by the ratio D90−D50/D50, which may exhibit a value of between about 0.5 to about 5, or about 0.5 to about 2, or about 0.5 to about 1, such as about 0.5, 1, 1.5, 2, 2.5, 3, 3.5, 4, 4.5, or 5.

The olivine cathode materials may optionally be characterized by their favorable electrochemical properties, such as high coulombic efficiency, first cycle specific discharge capacity, average discharge voltage, energy density, dQ·dV⁻¹ peaks, rate capability, and low-temperature performance when incorporated into an electrochemical cell. Unless otherwise noted, the performance characteristics of the mixture may be tested with standard half-cell conditions versus a lithium metal anode, with a polypropylene separator, with a carbonate electrolyte, at room temperature, cycled to a lower voltage limit of about 2.5 V vs. Li⁺/Li and an upper voltage limit of between 4.0 V and 4.5 V vs. Li⁺/Li, and at a current rate of between C/20 and C/10. It will be appreciated that an upper voltage limit less than 4.5 V will result in lower specific discharge capacity, lower average discharge voltage, and lower energy density. It will be appreciated that a current rate slower than C/10 may result in slightly higher specific discharge capacity, average discharge voltage, and energy density.

The coulombic efficiency of the first cycle may be between about 92% to about 99%, such as about 92%, 93%, 94%, 95%, 96%, 97%, 98%, or 99%. The first cycle specific discharge capacity may be from about 140 mAh·g⁻¹ to about 170 mAh·g⁻¹, such as about 140 mAh·g⁻¹, 145 mAh·g⁻¹, 150 mAh·g⁻¹, 155 mAh·g⁻¹, 160 mAh·g⁻¹, 165 mAh·g⁻¹, or 170 mAh·g⁻¹. The addition of manganese can raise the average voltage of the olivine cathode from about 3.2 V vs. Li⁺/Li for LiFePO₄ to be from about 3.5 V vs. Li⁺/Li to about 4.2 V vs. Li⁺/Li for the present materials, matching closer to the high average discharge voltage of lithium layered-oxide cathode materials. Example values include about 3.50 V, 3.51 V, 3.52 V, 3.53 V, 3.54 V, 3.55 V, 3.56 V, 3.57 V, 3.58 V, 3.59 V, 3.60 V, 3.61 V, 3.62 V, 3.63 V, 3.64 V, 3.65 V, 3.66 V, 3.67 V, 3.68 V, 3.69 V, 3.70 V, 3.71 V, 3.72 V, 3.73 V, 3.74 V, 3.75 V, 3.76 V, 3.77 V, 3.78 V, 3.79 V, 3.80 V, 3.81 V, 3.82 V, 3.83 V, 3.84 V, 3.85 V, 3.86 V, 3.87 V, 3.88 V, 3.89 V, 3.90 V, 3.91 V, 3.92 V, 3.93 V, 3.94 V, 3.95 V, 3.96 V, 3.97 V, 3.98 V, 3.99 V, 4.00 V, 4.01 V, 4.02 V, 4.03 V, 4.04 V, 4.05 V, 4.06 V, 4.07 V, 4.08 V, 4.09 V, 4.10 V, 4.11 V, 4.12 V, 4.13 V, 4.14 V, 4.15 V, 4.16 V, 4.17 V, 4.18 V, 4.19 V, or 4.20 V vs. Li⁺/Li. The cathode-level energy density may be from about 490 Wh·kg⁻¹ to about 715 Wh·kg⁻¹, such as about 490 Wh·kg⁻¹, 500 Wh·kg⁻¹, 510 Wh·kg⁻¹, 520 Wh·kg⁻¹, 530 Wh·kg⁻¹, 540 Wh·kg⁻¹, 550 Wh·kg⁻¹, 560 Wh·kg⁻¹, 570 Wh·kg⁻¹, 580 Wh·kg⁻¹, 590 Wh·kg⁻¹, 600 Wh·kg⁻¹, 610 Wh·kg⁻¹, 620 Wh·kg⁻¹, 630 Wh·kg⁻¹, 640 Wh·kg⁻¹, 650 Wh·kg⁻¹, 660 Wh·kg⁻¹, 670 Wh·kg⁻¹, 680 Wh·kg⁻¹, 690 Wh·kg⁻¹, 700 Wh·kg⁻¹, or 715 Wh·kg⁻¹. The dQ·dV⁻¹ curves may reveal a high-voltage peak during the second discharge such that there is a local minimum between about 3.8 V vs. Li⁺/Li and about 4.3 V vs. Li⁺/Li. The mixture may be characterized by good rate capability, such that at least about 90% of discharge capacity may be retained during a 1C discharge step relative to a previous C/10 charge and discharge cycle, such as about 90%, 91%, 92%, 93%, 94%, 95%, 96%, 97%, 98%, 99%, or 100%. The charge step of the 1C cycle may have a current rate between C/10 and 1C. The low-temperature specific discharge capacity at about −20° C. may be from about 100 mAh·g⁻¹ to about 170 mAh·g⁻¹, such as about 100 mAh·g⁻¹, 105 mAh·g⁻¹, 110 mAh·g⁻¹, 115 mAh·g⁻¹, 120 mAh·g⁻¹, 125 mAh·g⁻¹, 130 mAh·g⁻¹, 135 mAh·g⁻¹, 140 mAh·g⁻¹, 145 mAh·g⁻¹, 150 mAh·g⁻¹, 155 mAh·g⁻¹, 160 mAh·g⁻¹, 165 mAh·g⁻¹, 170 mAh·g⁻¹. The capacity retention at −20° C. relative to room temperature may be at least 60%, such as about 60%, 65%, 70%, 75%, 80%, 85%, 90%, 95%, or 100%. The capacity retention at −20° C. relative to room temperature, when cycled at a current rate of 1C, may be at least 60%, such as about 60%, 65%, 70%, 75%, 80%, 85%, 90%, 95%, or 100%.

### Layered-Oxide Cathode Materials

The lithium layered-oxide cathode materials described herein, also referred to as layered-oxide cathodes or layered oxides, comprise or are characterized by a chemical formula of Li_{d}Ni_{1-e-f}CoₑM_{f}O_{g}. Here, M represents one or more metals and/or non-metals, such as Mn, Al, Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm, or any combination of these.

The subscript d in the chemical formula Li_{d}Ni_{1-e-f}CoₑM_{f}O_{g} represents the relative amount of Li (lithium) in the electrode active materials. In general, the amount of Li can vary from Li-excess to Li-deficient. For example, d may be from about 0.9 to about 1.1, from 0.9 to 1.09, from 0.9 to 1.08, from 0.9 to 1.07, from 0.9 to 1.06, from 0.9 to 1.05, from 0.9 to 1.04, from 0.9 to 1.03, from 0.9 to 1.02, from 0.9 to 1.01, from 0.9 to 1.0, from 0.91 to 1.1, from 0.92 to 1.1, from 0.93 to 1.1, from 0.94 to 1.1, from 0.95 to 1.1, from 0.96 to 1.1, from 0.97 to 1.1, from 0.98 to 1.1, from 0.99 to 1.1, or from 0.95 to 1.05.

The subscript e in the chemical formula Li_{d}Ni_{1-e-f}CoₑM_{f}O_{g} represents the relative amount of Co (cobalt) in the electrode active materials. In general, the amount of Co is almost zero, for example from about 0 to 0.05, from 0 to 0.045, from 0 to 0.04, from 0 to 0.035, from 0 to 0.03, from 0 to 0.025, from 0 to 0.02, from 0 to 0.015, from 0 to 0.01, from 0 to 0.005, or in some cases, e may be or may be about 0.

The subscript f in the chemical formula Li_{d}Ni_{1-e-f}CoₑM_{f}O_{g} represents the relative amount of metal(s) and/or non-metal(s) M in the electrode active materials. In general, f can vary from about 0 to about 0.6. In some cases, d may be from about 0 to about 0.55, from 0 to 0.5, from 0 to 0.45, from 0 to 0.4, from 0 to 0.35, from 0 to 0.3, from 0.05 to 0.6, from 0.05 to 0.55, from 0.05 to 0.5, from 0.05 to 0.45, from 0.05 to 0.4, from 0.05 to 0.35, from 0.05 to 0.3, from 0.1 to 0.6, from 0.1 to 0.55, from 0.1 to 0.5, from 0.1 to 0.45, from 0.1 to 0.4, from 0.1 to 0.35, or from 0.1 to 0.3. Since M can correspond to one or multiple metals and/or non-metals, it will be appreciated that the stoichiometric coefficient for the individual metals and/or non-metals may total to d. Example values for d may be or may be about 0.00, 0.05, 0.10, 0.15, 0.20, 0.25, 0.30, 0.35, 0.40, 0.45, 0.50, 0.55, or 0.60.

The subscript g in the chemical formula Li_{d}Ni_{1-e-f}CoₑM_{f}O_{g} represents the relative amount of O (oxygen) in the electrode active materials. As a result of minor defects in the crystal structure, oxygen may vary from about 1.9 to about 2.1, or from 1.95 to 2.05, from 1.9 to 2.0, from 1.95 to 2.05, from 2.0 to 2.05, or from 2.05 to 2.1. In some cases, e may be or may be about 1.9, 1.905, 1.91, 1.915, 1.92, 1.925, 1.93, 1.935, 1.94, 1.945, 1.95, 1.955, 1.96, 1.965, 1.97, 1.975, 1.98, 1.985, 1.99, 1.995, 2, 2.005, 2.01, 2.015, 2.02, 2.025, 2.03, 2.035, 2.04, 2.045, 2.05, 2.055, 2.06, 2.065, 2.07, 2.075, 2.08, 2.085, 2.09, 2.095, 2.1.

The electrode active materials may be in or prepared in a powder form, such as comprising individual secondary particles having cross-sectional dimensions (e.g., diameters) of from about 500 nm to about 30 μm. For example, the cross-sectional dimensions may be from 500 nm to 1.0 μm, from 500 nm to 10 μm, from 500 nm to 20 μm, from 1.0 μm to 10 μm, from 1.0 μm to 20 μm, from 2.5 μm to 5.0 μm, from 5.0 μm to 7.5 μm, from 7.5 μm to 10 μm, from 10 μm to 15 μm, from 15 μm to 20 μm, or from 20 μm to 30 μm. The individual secondary particles may, additionally, be spherical in shape. The spherical secondary particles may, additionally, be composed of many smaller primary particles stuck together.

The individual secondary particles may have a uniform distribution of particle sizes. Size distribution may be described by (D90−D10)/D50 where the number corresponds to the percentage of a particle population, meaning D10 is equivalent to the size (e.g., diameter) for which 10% of the particle population is smaller and D90 is equivalent to the size for which 90% of the particle population is smaller. The individual secondary particles may have a size distribution corresponding to a (D90−D10)/D50 of about 1.0 or lower. For example, the size distribution corresponding to a (D90−D10)/D50 may be about 1.0, 0.9, 0.8, 0.7, 0.6, 0.5, 0.4, 0.3, 0.2, or 0.1. In another example, the primary particles may be encased in a spherical carbon matrix between about 1 um to about 30 um in diameter.

The individual secondary particles may have a uniform distribution of metals throughout the entire particle. This may be described as an equal ratio of each metal throughout the particle, from the very center to the surface. In another example, the individual secondary particles may have a non-uniform distribution of metals, characterized by a different proportion of metals on the 20% surface-most region of the particles.

### Mixture of Olivine and Layered-Oxide Cathode Materials

Example mixtures of the present disclosure comprise the olivine cathode materials and the lithium layered-oxide cathode materials described above. The mixture of the two cathode materials may allow for an improvement in physical or electrochemical properties while minimizing cobalt and nickel content. The ratio of olivine cathode to layered-oxide cathode may be a mass ratio between about 5% olivine cathode, 95% layered oxides (5:95) to about 95% olivine cathode, 5% layered oxides (95:5), or about 5% olivine cathode, 95% layered oxides (5:95) to about 60% olivine cathode, 40% layered oxides (60:40), or about 5% olivine cathode, 95% layered oxides (5:95) to about 50% olivine cathode, 50% layered oxides (50:50), or about 5% olivine cathode, 95% layered oxides (5:95) to about 40% olivine cathode, 60% layered oxides (40:60), such as about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. The ratio may alternatively be a volume ratio between about 5% olivine cathode, 95% layered oxides (5:95) to about 95% olivine cathode, 5% layered oxides (95:5), or about 5% olivine cathode, 95% layered oxides (5:95) to about 60% olivine cathode, 40% layered oxides (60:40), or about 5% olivine cathode, 95% layered oxides (5:95) to about 50% olivine cathode, 50% layered oxides (50:50), or about 5% olivine cathode, 95% layered oxides (5:95) to about 40% olivine cathode, 60% layered oxides (40:60), such as about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. The ratio may alternatively be a particle population ratio between about 5% olivine cathode, 95% layered oxides (5:95) to about 95% olivine cathode, 5% layered oxides (95:5), or about 5% olivine cathode, 95% layered oxides (5:95) to about 60% olivine cathode, 40% layered oxides (60:40), or about 5% olivine cathode, 95% layered oxides (5:95) to about 50% olivine cathode, 50% layered oxides (50:50), or about 5% olivine cathode, 95% layered oxides (5:95) to about 40% olivine cathode, 60% layered oxides (40:60), such as about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. Optionally, the mixture may be defined by a total cobalt content of about 3% or less.

The mixture may be characterized by a low moisture content to minimize degradation of the lithium layered-oxide cathode, such as about 800 ppm or less, 700 ppm or less, 600 ppm or less, 500 ppm or less, 400 ppm or less, or 300 ppm or less.

The olivine-cathode particles and layered-oxide particles of the mixture may have a size ratio of between about 1:2.5 and 1:50, respectively, defined by the median particle size of each cathode type. For example, the median particle size of the olivine cathode materials may be about 1 μm and the layered oxides 2.5 μm. Further examples of the particle size ratio between the olivine cathode and layered oxides include 1:2.5, 1:3, 1:4, 1:5, 1:6, 1:8, 1:10, 1:12, 1:14, 1:16, 1:18, 1:20, 1:22, 1:24, 1:26, 1:28, 1:30, 1:32, 1:34, 1:36, 1:38, 1:40, 1:42, 1:44, 1:46, 1:48, or 1:50.

Optionally, the majority of the olivine-cathode particles may be bound to the surface of the layered-oxide particles, such as between about 50% to about 100% of the olivine-cathode particles. For example, the olivine-cathode particles may be chemically or mechanically bound to the surface of the layered-oxide particles, such as by forming a coating on the layered-oxide particle surface, such that the layered-oxide particles are less exposed to air and electrolyte (e.g., as compared to the layered-oxide particles without olivine-cathode particles), reducing degradation. The coating may optionally surround the surface of the layered-oxide particles completely. The extent of particle bonding may be estimated optically with scanning electron microscopy (SEM) or quantified with particle size analysis (PSA) by measuring before and after the two cathodes are combined. Bound particles may reduce processing requirements by minimizing additional mixing steps required after storage or transport of the mixture. The distribution of olivine-cathode particles and layered-oxide particles within a powder sample may remain well dispersed after sample agitation, as identified via a uniform color gradation throughout a container of sample, by an inductively coupled plasma (ICP) spectroscopy technique, or by particle size analysis. For example, the reduction in processing requirements may be quantified by measuring median particle size distribution using a particle size analyzer (PSA) on sample from the top and bottom of a container after tapping at least 100 times (such as with a tap density machine). The mixture may only exhibit between about a 0% to about a 10% change in median particle size between the top 20 vol. % and bottom 20 vol. % of the container, such as about 0%, 1%, 2%, 3%, 4%, 5%, 6%, 7%, 8%, 9%, or 10%.

The mixture may be characterized by good stability in air and moisture, such that the increase in residual lithium species after exposure to humid air at room temperature is between about 0% to about 20%, or from about 0% to 10%, or from about 0% to 5%, such as about 0%, 1%, 2%, 3%, 4%, 5%, 6%, 7%, 8%, 9%, 10%, 11%, 12%, 13%, 14%, 15%, 16%, 17%, 18%, 19%, or 20%. Residual lithium species, such as LiOH and Li₂CO₃, may be measured by stirring the lithium-based cathode material in degassed, deionized water at a mass ratio of 1 part cathode material to 50 parts water for 10 minutes; the water may then be filtered and titrated to find the total moles of residual lithium species.

The mixture may achieve a high density, such that the tap density is from about 0.5 g·cm⁻³ to about 3.5 g·cm⁻³, for example 0.5 g·cm⁻³, 0.6 g·cm⁻³, 0.7 g·cm⁻³, 0.8 g·cm⁻³, 0.9 g·cm⁻³, 1.0 g·cm⁻³, 1.1 g·cm⁻³, 1.2 g·cm⁻³, 1.3 g·cm⁻³, 1.4 g·cm⁻³, 1.5 g·cm⁻³, 1.6 g·cm⁻³, 1.7 g·cm⁻³, 1.8 g·cm⁻³, 1.9 g·cm⁻³, 2.0 g·cm⁻³, 2.1 g·cm⁻³, 2.2 g·cm⁻³, 2.3 g·cm⁻³, 2.4 g·cm⁻³, 2.5 g·cm⁻³, 2.6 g·cm⁻³, 2.7 g·cm⁻³, 2.8 g·cm⁻³, 2.9 g·cm⁻³, 3.0 g·cm⁻³, 3.1 g·cm⁻³, 3.2 g·cm⁻³, 3.3 g·cm⁻³, 3.4 g·cm⁻³, or 3.5 g·cm⁻³. Pressed density may be measured after an exerted pressure of about 275 MPa or less on the mixture. The pressed density may be about 0.5 g·cm⁻³ to about 4 g·cm⁻³, or about 1.5 g·cm⁻³ to about 4 g·cm⁻³, or about 2.5 g·cm⁻³ to about 4 g·cm⁻³, such as about 0.5 g·cm⁻³, 1.0 g·cm⁻³, 1.5 g·cm⁻³, 2.0 g·cm⁻³, 2.5 g·cm⁻³, 2.6 g·cm⁻³, 2.7 g·cm⁻³, 2.8 g·cm⁻³, 2.9 g·cm⁻³, 3.0 g·cm⁻³, 3.1 g·cm⁻³, 3.2 g·cm⁻³, 3.3 g·cm⁻³, 3.4 g·cm⁻³, or 3.5 g·cm⁻³, 3.6 g·cm⁻³, 3.7 g·cm⁻³, 3.8 g·cm⁻³, 3.9 g·cm⁻³, or 4.0 g·cm⁻³. While measuring pressed density, the resistivity of the mixture after an exerted pressure may be found by measuring voltage and current with a 4-point probe on the top and bottom of the powder sample. The resistivity of the powder may be between about 1 Ω·cm to about 100 Ω·cm, or from 1 Ω·cm to 50 Ω·cm, or from 1 Ω·cm to 40 Ω·cm, or from 1 Ω·cm to 30 Ω·cm, or from 1 Ω·cm to 20 Ω·cm, or from 1 Ω·cm to 10 Ω·cm, such as about 1 Ω·cm, 5 Ω·cm, 10 Ω·cm, 15 Ω·cm, 20 Ω·cm, 25 Ω·cm, 30 Ω·cm, 35 Ω·cm, 40 Ω·cm, 45 Ω·cm, 50 Ω·cm, 55 Ω·cm, 60 Ω·cm, 65 Ω·cm, 70 Ω·cm, 75 Ω·cm, 80 Ω·cm, 85 Ω·cm, 90 Ω·cm, 95 Ω·cm, or 100 Ω·cm.

For the purpose of reducing surface exposure and improving the mixture's processability, the present materials may be characterized by a low surface area of about 0.2 m²·g⁻¹ to about 100 m²·g⁻¹, or about 0.2 m²·g⁻¹ to about 50 m²·g⁻¹, or about 0.2 m²·g⁻¹ to about 20 m²·g⁻¹, or about 0.2 m²·g⁻¹ to about 10 m²·g⁻¹, such as about 0.2 m²·g⁻¹, 0.5 m²·g⁻¹, 1 m²·g⁻¹, 2 m²·g⁻¹, 3 m²·g⁻¹, 4 m²·g⁻¹, 5 m²·g⁻¹, 6 m²·g⁻¹, 7 m²·g⁻¹, 8 m²·g⁻¹, 9 m²·g⁻¹, 10 m²·g⁻¹, 11 m²·g⁻¹, 12 m²·g⁻¹, 13 m²·g⁻¹, 14 m²·g⁻¹, 15 m²·g⁻¹, 16 m²·g⁻¹, 17 m²·g⁻¹, 18 m²·g⁻¹, 19 m²·g⁻¹, 20 m²·g⁻¹, 25 m²·g⁻¹, 30 m²·g⁻¹, 35 m²·g⁻¹, 40 m²·g⁻¹, 45 m²·g⁻¹, 50 m²·g⁻¹, 60 m²·g⁻¹, 70 m²·g⁻¹, 80 m²·g⁻¹, 90 m²·g⁻¹, or 100 m²·g⁻¹. Additionally, the solvent absorption content may be approximated with a standard oil absorption test with a standard oil absorption test, such as the spatula rub-out ASTM D281 method, using dibutyl phthalate (DBP) oil. Example values of DBP absorption may range from about 100 mL per 100 g of olivine cathode to about 500 mL per 100 g of olivine cathode, or from 100 mL to 400 mL, or from 100 mL to 300 mL, or from 100 mL to 200 mL, such as about 100 mL, 150 mL, 200 mL, 250 mL, 300 mL, 350 mL, 400 mL, 450 mL, or 500 mL. Alternatively, the content of NMP necessary for electrode preparation may be closely approximated by substituting the oil for NMP in a standard oil absorption test. Example values of NMP absorption may be from about 0.5 mL per 100 g of olivine cathode to about 5 mL per 100 g of olivine cathode, or from 0.5 mL to 4.5 mL, or from 0.5 mL to 4 mL, or from 0.5 mL to 3.5 mL, or from 0.5 mL to 3 mL, such as about 0.5 mL per 100 g, 1 mL per 100 g, 1.5 mL per 100 g, 2 mL per 100 g, 2.5 mL per 100 g, 3 mL per 100 g, 3.5 mL per 100 g, 4 mL per 100 g, 4.5 mL per 100 g, or 5 mL per 100 g. Furthermore, the oil absorption test may be used to approximate necessary electrolyte content in a cell made with the olivine cathode materials by substituting oil for a carbonate solvent. Example values of carbonate solvent absorption may include about 10 mL per 100 g of olivine cathode to about 500 mL per 100 g of olivine cathode, or from 10 mL to 400 mL, or from 10 mL to 300 mL, or from 10 mL to 200 mL, or from 10 mL to 100 mL, such as about 10 mL, 50 mL, 100 mL, 150 mL, 200 mL, 250 mL, 300 mL, 350 mL, 400 mL, 450 mL, or 500 mL per 100 g.

Safety is an important metric for lithium-ion batteries and the mixture may be surprisingly and unexpectedly characterized by better safety metrics than the individual components would suggest. Differential scanning calorimetry (DSC) is one technique for quantifying the safety of a given lithium cathode material when charged. For example, the mixture may be characterized by a maximum heat flow per gram of mixture, such as between about 0.1 W·g⁻¹ to about 10 W·g⁻¹, between 0.1 W·g⁻¹ to 5 W·g⁻¹, between 0.1 W·g⁻¹ to 2 W·g⁻¹, or between 0.1 W·g⁻¹ to 1 W·g⁻¹, such as about 10 W·g⁻¹ or less, 5 W·g⁻¹ or less, 2 W·g⁻¹ or less, 1.0 W·g⁻¹ or less, 0.9 W·g⁻¹ or less, 0.8 W·g⁻¹ or less, 0.7 W·g⁻¹ or less, 0.6 W·g⁻¹ or less, 0.5 W·g⁻¹ or less, or 0.4 W·g⁻¹ or less. In another example, the mixture may be characterized by a temperature at which peak heat flow occurs, such as between about 150° C. to about 350° C., about 160° C. to 350° C., about 170° C. to 350° C., about 180° C. to 350° C., about 190° C. to 350° C., about 200° C. to 350° C., about 200° C. to 350° C., about 210° C. to 350° C., about 220° C. to 350° C., about 230° C. to 350° C., about 235° C. to 350° C., about 240° C. to 350° C., about 245° C. to 350° C., or about 250° C. to 350° C. DSC testing conditions are measured by first charging material to an upper cutoff voltage of between 4.0 V and 4.5 V vs. Li⁺/Li with standard half-cell conditions versus a lithium metal anode, with a polypropylene separator, with a carbonate electrolyte, at room temperature, and at a current rate of between C/20 and C/10. The cell is then disassembled in an inert atmosphere, the cathode is gently rinsed with dimethyl carbonate (DMC), and the cathode is then dried. Between about 5 mg to about 50 mg of cathode is then scraped into a vessel and a standard carbonate electrolyte is added in between a 5:5 and 9:3 cathode/electrolyte weight ratio. The vessel is then sealed tight and heated under flowing Ar gas.

In another example, the safety of the mixture may be measured with accelerating rate calorimetry (ARC). The mixture may exhibit a peak heating rate per Ah of mixture, such as between about 0.5° C.·m⁻¹Ah⁻¹ to about 500° C.·m⁻¹Ah⁻¹, between 0.5° C.·m⁻¹Ah⁻¹ to 400° C.·m⁻¹Ah⁻¹, between 0.5° C.·m⁻¹Ah⁻¹ to 300° C.·m⁻¹Ah⁻¹, between 0.5° C.·m⁻¹Ah⁻¹ to 200° C.·m⁻¹Ah⁻¹, or between 0.5° C.·m⁻¹Ah⁻¹ to 100° C.·m⁻¹Ah⁻¹, such as about 400° C.·m⁻¹Ah⁻¹ or less, about 300° C.·m⁻¹Ah⁻¹ or less, about 200° C.·m⁻¹Ah⁻¹ or less, about 100° C.·m⁻¹Ah⁻¹ or less, 90° C.·m⁻¹Ah⁻¹ or less, 80° C.·m⁻¹Ah⁻¹ or less, 70° C.·m⁻³Ah⁻¹ or less, 60° C.·m⁻³Ah⁻¹ or less, 50° C.·m⁻¹Ah⁻¹ or less, 40° C.·m⁻¹Ah⁻¹ or less, 30° C.·m⁻¹Ah⁻¹ or less, 20° C.·m⁻¹Ah⁻¹ or less, 10° C.·m⁻¹Ah⁻¹ or less, or 5° C.·m⁻¹Ah⁻¹ or less. In another example, the mixture may exhibit a temperature before thermal runaway occurs, characterized by a rapid increase in heating rate, such as between about 150° C. to about 350° C., about 160° C. to 350° C., about 170° C. to 350° C., about 180° C. to 350° C., about 190° C. to 350° C., about 200° C. to 350° C., about 200° C. to 350° C., about 210° C. to 350° C., about 220° C. to 350° C., about 230° C. to 350° C., about 235° C. to 350° C., about 240° C. to 350° C., about 245° C. to 350° C., or about 250° C. to 350° C. ARC testing conditions are measured by first charging material to an upper cutoff voltage of between 4.0 V and 4.5 V vs. Li⁺/Li with standard half-cell conditions versus a lithium metal anode, with a polypropylene separator, with a carbonate electrolyte, at room temperature, and at a current rate of between C/20 and C/10. The cell is then disassembled in an inert atmosphere, the cathode is gently rinsed with dimethyl carbonate (DMC), and the cathode is then dried. Between about 5 mg to about 50 mg of cathode is then scraped into a vessel and a standard carbonate electrolyte is added in between a 5:5 and 9:3 cathode/electrolyte weight ratio. The vessel is then sealed tight and heated under flowing Ar gas.

The mixture described herein may be characterized by improved electrochemical performance, such as high coulombic efficiency, first cycle specific capacity, average discharge voltage, energy density, dQ·dV⁻¹ peaks, rate capability, calendar life, and low temperature performance when incorporated into an electrochemical cell. Unless otherwise noted, the performance characteristics of the mixture may be tested with standard half-cell conditions versus a lithium metal anode, with a polypropylene separator, with a carbonate electrolyte, at room temperature, cycled to a lower voltage limit of about 2.5 V vs. Li⁺/Li and an upper voltage limit of between 4.0 V and 4.5 V vs. Li⁺/Li, and at a current rate of between C/20 and C/10. It will be appreciated that an upper voltage limit less than 4.5 V will result in lower specific discharge capacity, lower average discharge voltage, and lower energy density. It will be appreciated that a current rate slower than C/10 may result in slightly higher specific discharge capacity, average discharge voltage, and energy density.

The coulombic efficiency of the first cycle may be between about 88% to about 99%, such as about 88%, 89%, 90%, 91%, 92%, 93%, 94%, 95%, 96%, 97%, 98%, or 99%. The first cycle specific discharge capacity may be from about 145 mAh·g⁻¹ to about 240 mAh·g⁻¹, or from about 155 mAh·g⁻¹ to about 230 mAh·g⁻¹, such as about 145 mAh·g⁻¹, 150 mAh·g⁻¹, 155 mAh·g⁻¹, 160 mAh·g⁻¹, 165 mAh·g⁻¹, 170 mAh·g⁻¹, 175 mAh·g⁻¹, 180 mAh·g⁻¹, 185 mAh·g⁻¹, 190 mAh·g⁻¹, 195 mAh·g⁻¹, 200 mAh·g⁻¹, 205 mAh·g⁻¹, 210 mAh·g⁻¹, 215 mAh·g⁻¹, 220 mAh·g⁻¹, 225 mAh·g⁻¹, 230 mAh·g⁻¹, 235 mAh·g⁻¹, or 240 mAh·g⁻¹. The average discharge voltage may be from about 3.5 V vs. Li⁺/Li to about 4.2 V vs. Li⁺/Li, such as about 3.5 V, 3.6 V, 3.7 V, 3.8 V, 3.9 V, 4.0 V, 4.1 V, or 4.2 V. The cathode-level energy density may be from about 500 Wh·kg⁻¹ to about 1,000 Wh·kg⁻¹, or from about 600 Wh·kg⁻¹ to about 900 Wh·kg⁻¹, such as about 500 Wh·kg⁻¹, 550 Wh·kg⁻¹, 600 Wh·kg⁻¹, 650 Wh·kg⁻¹, 700 Wh·kg⁻¹, 750 Wh·kg⁻¹, 800 Wh·kg⁻¹, 850 Wh·kg⁻¹, 900 Wh·kg⁻¹, 950 Wh·kg⁻¹, or 1,000 Wh·kg⁻¹. The dQ·dV⁻¹ curves may reveal a high-voltage peak during the second discharge such that there is a local minimum between about 3.8 V vs. Li⁺/Li and about 4.3 V vs. Li⁺/Li. Furthermore, the mixture may exhibit two or more local minima in the dQ·dV⁻¹ curves between about 3.8 V vs. Li⁺/Li and about 4.3 V vs. Li⁺/Li, such as two to four local minima. The mixture may be characterized by good rate capability, such that at least 85% of capacity may be retained during a 1C discharge step relative to a previous C/10 charge and discharge cycle, such as about 90%, 91%, 92%, 93%, 94%, 95%, 96%, 97%, 98%, 99%, or 100%. The charge step of the 1C cycle may have a current rate between C/10 and 1C. The mixture may be characterized by a good calendar life after at least a month of resting and up to two years of resting in a charged state of 4.3 V or higher, relative to the last discharge step before resting and at room temperature. Calendar life testing is performed by first bringing the cell to the upper voltage cutoff then removing any additional current flow during the resting period. At least about 95% of capacity may be retained, such as about 96%, 97%, 98%, 99%, or 100%. The low-temperature specific discharge capacity at about −20° C. may be from about 100 mAh·g⁻¹ to about 180 mAh·g⁻¹, or about 120 mAh·g⁻¹ to about 180 mAh·g⁻¹, such as about 120 mAh·g⁻¹, 130 mAh·g⁻¹, 140 mAh·g⁻¹, 150 mAh·g⁻¹, 160 mAh·g⁻¹, 170 mAh·g⁻¹, or 180 mAh·g⁻¹. The capacity retention at −20° C. relative to room temperature may be at least 60%, such as about 60%, 65%, 70%, 75%, 80%, 85%, 90%, 95%, or 100%. The capacity retention at −20° C. relative to room temperature, when cycled at a current rate of 1C, may be at least 60%, such as about 60%, 65%, 70%, 75%, 80%, 85%, 90%, 95%, or 100%.

### Electrochemical Cells

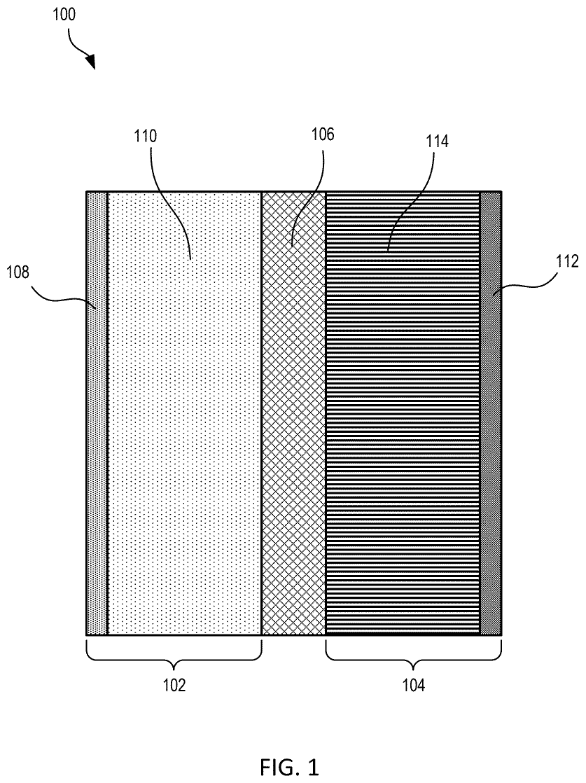

The cathode materials described herein can be useful in electrochemical cells and batteries. FIG. 1 provides a schematic illustration of an example electrochemical cell 100, which comprises a cathode 102, an anode 104, and a separator 106. The cathode 102 comprises a current collector 108 and a cathode material 110. The anode 104 comprises a current collector 112 and an anode material 114. Additionally, electrolyte may be located as or with the separator 106 in solid form or in liquid form distributed throughout the cell 100. Additionally, the cell may be encased in an outer structure.

In an example, the cathode material 110 may be formed by mixing the electrode active materials of the present disclosure with a conductive carbon, polymeric binder, and NMP solvent then depositing the mixture onto the surface of a current collector 108, such as aluminum. The anode active material may include, but is not limited to, graphite, carbon, silicon, lithium titanate (Li₄Ti₅O₁₂), tin, antimony, zinc, phosphorous, lithium, any combination thereof, or nothing (e.g., anode-free). The anode active material may be mixed with a conductive carbon, polymeric binder, and deposited onto the surface of a current collector 112, such as copper.

The separator 106 may be any suitable non-reactive material, such as a porous structure. Example separators may be polymeric membranes like polypropylene, poly(methyl methacrylate), or polyacrylonitrile, or may be solid or ceramic electrolytes. The separator 106 may include (e.g., have pores filled with) an electrolyte or may function as an electrolyte itself, which may be used to conduct ions back and forth between the cathode material 110 and the anode material 114. Example electrolytes may be or include an organic solvent, such as ethylene carbonate, dimethyl carbonate, fluoroethylene carbonate, vinylene carbonate, diethyl carbonate, or dimethyl ether, or solid or ceramic electrolytes. Electrolytes may include dissolved lithium salts, such as LiPF₆, LiBF₄, LiFSI, LiTFSI, or LiClO₄, and other additives. Electrolytes may also include inert diluents for reducing the electrolyte viscosity, such as 1,1,2,2-tetrafluoroethylene 2,2,3,3-tetrafluoropropyl ether (TTE).

### Methods

The olivine cathode materials of the present disclosure may be synthesized via different processes, such as a solid-state method, hydrothermal synthesis method, melt synthesis method, reaction method, mineralization method, or other method. For example, one method may involve grinding together a stoichiometric ratio of a lithium salt, such as lithium carbonate (Li₂CO₃) or lithium hydroxide (LiOH), with an iron salt, such as iron phosphate (FePO₄), iron oxide (Fe₃O₄, Fe₂O₃, or FeO), iron sulfate (FeSO₄), or iron nitrate (Fe(NO₃)₂), a manganese salt, such as manganese oxide (MnO₂ or Mn₃O₄), manganese sulfate (MnSO₄), manganese carbonate (MnCO₃), or manganese nitrate (Fe(NO₃)₂), and a phosphate source, such as ammonium dihydrogen phosphate. The salts may be ground with or without a liquid solvent, such as water, and a carbon source added to the mixture, for example glucose or graphite. The resulting mixture may then be dried and calcined in a furnace between 600° C. and 800° C. for 5 to 20 hours.

Moisture content may be minimized during calcination by flowing a dry, inert gas through the furnace. After calcination, the material may optionally be exposed to vacuum and heat between about 80° C. to about 300° C. for 5 to 24 hours and purged with dry nitrogen or argon. Surface treatments may further be applied to improve material performance and minimize moisture content, such as the addition of a hydrophilic surface layer. Surface area and extent of oil (or NMP/solvent) absorption may be minimized by reducing pore size before or after calcination, for example by crushing the particles. Example methods for improving powder resistivity may include increasing carbon content, reducing manganese content, improving metal uniformity within the material, adding conductive additives such as metal dopants, or reducing particle size. Example methods for increasing average discharge voltage may include increasing manganese content, increasing carbon content, the addition of metal dopants, or decreasing particle size.

In examples, the lithium layered-oxide materials may be synthesized by one of co-precipitation, sol-gel synthesis, solid-state synthesis, plasma synthesis, or molten-salt synthesis which may or may not be followed by a calcination step. The lithium source, such as lithium carbonate, lithium hydroxide, lithium acetate, lithium oxide, lithium oxalate, lithium nitrate, or any combination thereof, may be added before the calcination step. The calcination conditions can include a maximum temperature of about 650° C. to about 1200° C., held for a time between 5 hours to 48 hours. The resulting material may then, optionally, be subjected to further surface treatments to reduce the residual lithium species and enhance the surface stability of the material.

An example of the co-precipitation method to synthesize Li_{d}Ni_{1-e-f}CoₑM_{f}O_{g} is to first dissolve the metal salts of nickel, cobalt, and M (including but not limited to nitrates, chlorides, acetates, sulfates, oxalates, or a combination thereof) in an aqueous solution with appropriate molar ratios. The concentration of the mixed-metal ion aqueous solution may be from 0.1 mol·L⁻¹ to 3.0 mol·L⁻¹. The mixed-metal ion aqueous solution is pumped into a tank reactor at a controlled rate under a non-oxidizing gaseous atmosphere. An aqueous solution of sodium hydroxide, potassium hydroxide, sodium carbonate, potassium carbonate, and a combination thereof, at 0.2 mol·L⁻¹ to 10 ·mol·L⁻¹ is separately pumped into the tank reactor to maintain a pH of 8.0 to 12.5. A chelating agent, for example an aqueous solution of ammonium hydroxide, is also pumped into the tank reactor to maintain an appropriate concentration of the chelating agent inside the tank reactor. The co-precipitation reaction takes place at a controlled temperature of 30° C. to 80° C. Subsequently, the resulting precursor is obtained after washing, filtering, and drying the material from the tank reactor. The precursor is then mixed with a lithium source and calcined.

In examples, the mixture of the present disclosure may be formed through different mixing procedures, such as stirring, blending, pressing, grinding, milling, or shaking. The mixing method may influence the properties and uniformity of the mixture, for example bonding of the olivine cathode particles to the surface of the layered oxide particles may be achieved through high energy blending or milling. In another example, a uniform distribution of particles may be achieved through longer periods of mixing, such as more than 1 minute. Sifting may also be performed after mixing to improve the physical properties and uniformity of the mixture.

### REFERENCES

Yang et al., 2021, “Olivine LiMnxFe1-xPO4 cathode materials for lithium ion batteries: restricted factors of rate performances,” j. Mater. Chem. A, 9, 14214-14232, DOI: 10.1039/D1TA01526E.
Zhange et al., 2021, “The prepared and electrochemical property of Mg-doped LiMn0.6Fe0.4PO4/C as cathode materials for lithium-ion batteries,” Ionics, 27, 4629-4637, DOI: 10.1007/s11581-021-04183-x.
Lyle et al., 2022, “Melt Synthesis of Lithium Manganese Iron Phosphate: Part I. Composition, Physical Properties, Structural Analysis, and Charge/Discharge Cycling,” 169, 060526, DOI: 10.1149/1945-7111/ac76e4.
Lyle et al., 2022, “Melt Synthesis of Lithium Manganese Iron Phosphate: Part II. Particle Size, Electrochemical Performance, and Solid-State Lithium Diffusion,” j. Electrochem. Soc., 169, 060527, DOI: 10.1149/1945-7111/ac76e5.
Trinh et al., 2021, “Hydrothermally synthesized nanostructured LiMnxFe1-xPO4 (x=0−0.3) cathode materials with enhanced properties for lithium-ion batteries,” Sci. Rep., 11, 12280, DOI: 10.1038/s41598-021-91881-1.
He et al., 2016, “The Synthesis of LiMnxFe1-xPO4/C Cathode Material through Solvothermal Jointed with Solid-State Reaction,” Materials, 9, 766, DOI: 10.3390/ma9090766.
Ouyang et al., 2021, “A comparative study on the reactivity of charged Ni-rich and Ni-poor positive electrodes with electrolyte at elevated temperatures using accelerating rate calorimetry,” J. Energy Chem., 60, 523-530, DOI: 10.1016/j.jechem.2021.01.036.
Li, W., Lee, S., Manthiram, A., 2020, “High-Nickel NMA: A Cobalt-Free Alternative to NMC and NCA Cathodes for Lithium-Ion Batteries,” Adv. Materials, 32, 2002718, DOI: 10.1002/adma.202002718.
Li et al., 2019, “Is Cobalt Needed in Ni-Rich Positive Electrode Materials for Lithium Ion Batteries?” J. Electrochem. Soc., 166, A429-A439, DOI: 10.1149/2.1381902jes.
Sun et al., 2013, “Cobalt-Free Nickel Rich Layered Oxide Cathodes for Lithium-Ion Batteries,” ACS App. Mater. & Interfaces, 5, 11434-11440, DOI: 10.1021/am403684z.
Li et al., 2015, “Electrochemical performance of LiNi0.5Mn0.5O2 with different synthesis methods,” Rare Met., 34, 580-585, DOI: 10.1007/s12598-013-0088-z.
U.S. Pat. Nos. 8,641,921, 8,734,676, 9,178,215, 11,094,936, 11,127,944, 11,233,239.
Chinese Patent Publication No. CN111933915A.

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “1, 2, 3, 1 and 2, 1 and 3, 2 and 3, or 1, 2, and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. An electrode active material comprising:
a phosphate having the chemical formula LiₐFe_{1-b-c}Mn_{b}M_{c}PO₄/C, wherein:
a is from 0.9 to 1.1,
b is from 0 to 1,
c is from 0 to 0.1, and
M is Ni, Al, Mg, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm, or any combination of these, wherein:
C is between about 0% to about 3% by weight, and a moisture content is under 800 ppm.

2. The electrode active material of claim 1, wherein a majority crystal structure of the phosphate is orthorhombic.

3. The electrode active material of claim 1, characterized by a pressed density after being subjected to a pressure of 275 MPa or less is about 2 g·cm⁻³ to about 3 g·cm⁻³.

4. The electrode active material of claim 1, characterized by an N-Methylpyrrolidone (NMP) absorption amount of between about 0.5 mL to about 5 mL per 100 g of electrode active material.

5. The electrode active material of claim 1, characterized by a dibutyl phthalate (DBP) oil absorption amount of between about 100 mL to about 500 mL per 100 g of electrode active material.

6. The electrode active material of claim 1, characterized by a D90−D50/D50 ratio of between about 0.5 to 5.

7. The electrode active material of claim 1, wherein C comprises an amorphous species, nanotubes, graphene, flakes, nanospheres, graphene oxide, or pyrolyzed carbon.

8. The electrode active material of claim 1, characterized by a first cycle coulombic efficiency of from about 92% to about 99% when incorporated into an electrochemical cell measured up to 4.5 V vs. Li⁺/Li or lower and at a current rate of C/10 or slower at room temperature.

9. The electrode active material of claim 1, characterized by an energy density of between about 490 Wh·kg⁻¹ to about 715 Wh·kg⁻¹ when incorporated into an electrochemical cell cycled up to 4.5 V vs. Li+/Li or lower, at a current rate of C/10 or slower, and at room temperature.

10. The electrode active material of claim 1, characterized by a dQ·dV⁻¹ curve during a second charge-discharge formation cycle exhibiting a local minimum during discharge at a voltage of from about 3.8 V to about 4.3 V vs. Li⁺/Li when incorporated into an electrochemical cell at room temperature and a current rate of C/10 or slower.

11. The electrode active material of claim 1, characterized by a capacity retention of cycling at 1C relative to C/10 of over 90% when incorporated into an electrochemical cell at room temperature and charged to 4.5 V vs. Li⁺/Li or lower.

12. The electrode active material of claim 1, characterized by a capacity retention of cycling at −20° C. relative to room temperature of over 60% when incorporated into an electrochemical cell at C/10 or slower and charged to 4.5 V vs. Li⁺/Li or lower.

13. An electrochemical device comprising:
a cathode comprising an electrode active material of a phosphate having the chemical formula LiₐFe_{1-b-c}Mn_{b}M_{c}PO₄/C, wherein:
a is from 0.9 to 1.1,
b is from 0 to 1,
c is from 0 to 0.1, and
M is Ni, Al, Mg, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm, or any combination of these, and C is between about 0% to about 3% by weight, and a moisture content is under 800 ppm;
an anode;
a separator between the anode and the cathode; and
an electrolyte.

14. A mixture comprising:
an electrode active material of a phosphate having the chemical formula LiₐFe_{1-b-c}Mn_{b}M_{c}PO₄/C, wherein:
a is from 0.9 to 1.1,
b is from 0 to 1,
c is from 0 to 0.1, and
M is Ni, Al, Mg, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm, or any combination of these, and C is between about 0% to about 3% by weight, and a moisture content is under 800 ppm; and
a lithium layered-oxide cathode material having the chemical formula Li_{d}Ni_{1-e-f}CoₑM_{f}O_{g} wherein:
d is from 0.9 to 1.1,
e is from 0 to 0.05,
f is from 0 to 0.6
g is from 1.9 to 2.1, and
M is Mn, Al, Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Tl, Sn, Sr, S, P, Cl, Ge, Sb, Er, Te, La, Ce, Nd, Dy, Eu, Sc, Se, Si, Tc, Pd, Pm, Sm, Gd, Tb, Ho, Tm, or any combination of these.

15. The mixture of claim 14, wherein a mass ratio of the electrode active material and the lithium layered-oxide cathode material is between about 5:95 and 95:5.

16. The mixture of claim 14, wherein a median particle size ratio of the electrode active material and the lithium layered-oxide cathode material is between about 1:2.5 and 1:50.

17. The mixture of claim 14, wherein a majority of the electrode active material is bound to a surface of the lithium layered-oxide cathode material.

18. The mixture of claim 14, wherein a 0% to 10% difference in particle size distribution exists between a top 20 vol. % and a bottom 20 vol. % after a standard tap density measurement of at least 100 taps.

19. The mixture of claim 14, characterized by a surface lithium amount increase of about 0% to about 20% after a week of humid air exposure at room temperature.

20. The mixture of claim 14, characterized by a pressed density after a pressure of 275 MPa or less of about 0.5 g·cm⁻³ to about 4 g·cm⁻³.

21. The mixture of claim 14, characterized by an N-Methylpyrrolidone (NMP) absorption amount of between about 0.5 mL to about 5 mL per 100 g of electrode active material.

22. The mixture of claim 14, characterized by a dibutyl phthalate (DBP) oil absorption amount of between about 100 mL to about 500 mL per 100 g of electrode active material.

23. The mixture of claim 14, characterized by a maximum heat flow between about 0.1 W·g⁻¹ to about 10 W·g¹ when measured by or subjected to differential scanning calorimetry (DSC).

24. The mixture of claim 14, characterized by a maximum heating rate of between about 0.5° C.·m⁻¹Ah⁻¹ to about 500° C.·m⁻¹Ah⁻¹ when measured by or subjected to accelerating rate calorimetry (ARC).

25. The mixture of claim 14, characterized by a first cycle coulombic efficiency of from about 88% to about 99% when measured in an electrochemical cell cycled up to 4.4 V vs. Li⁺/Li or lower at a current rate of C/10 or slower at room temperature.

26. The mixture of claim 14, characterized by an energy density of between about 500 Wh·kg⁻¹ to about 1,000 Wh·kg⁻¹ when measured in an electrochemical cell cycled up to 4.4 V vs. Li⁺/Li or lower, at a current rate of C/10 or slower, and at room temperature.

27. The mixture of claim 14, characterized by a dQ·dV⁻¹ curve during a second charge-discharge formation cycle exhibiting one or more local minima during discharge at a voltage of from about 3.8 V to about 4.3 V vs. Li⁺/Li when measured in an electrochemical cell at a current rate of C/10 or slower at room temperature.

28. The mixture of claim 14, characterized by a capacity retention of cycling at 1C relative to C/10 of over 85% when measured in an electrochemical cell at room temperature and charged to 4.4 V vs. Li⁺/Li or lower.

29. The mixture of claim 14, characterized by a capacity retention of cycling at −20° C. relative to room temperature of over 60% when measured in an electrochemical cell at C/10 or slower and charged to 4.4 V vs. Li⁺/Li or lower.
